(19) United States
(12) Patent Application Publication
(10) Pub. No.: US 2025/0328607 A1
(43) Pub. Date: Oct. 23, 2025

(54) A SYSTEM FOR MANAGING DISTRIBUTED DIGITAL RIGHTS

(71) Applicant: RAIR Technologies, Inc., Dover, DE (US)

(72) Inventors: Andrew Garrett Minks, Lago Vista, TX (US); Eduardo J. Prado, Newport Beach, CA (US); Gunther W. Sonnenfeld, II, Pembroke Pines, FL (US)

(21) Appl. No.: 18/870,216

(22) PCT Filed: May 24, 2023
(86) PCT No.: PCT/US2023/023409

§ 371 Date: Nov. 27, 2024

Related U.S. Application Data
(60) Provisional application No. 63/346,874, filed on May 29, 2022.

(51) Int. Cl. G06F 21/10; H04L 9/00; H04L 9/32

(52) U.S. Cl. CPC G06F 21/1014; H04L 9/3271; H04L 9/50

(57) ABSTRACT

A method and system for managing distributed digital rights is described.

### BACKGROUND

Infrastructure choices for the distribution of digital assets continue to develop. For example, conventional uni-directional networks are being replaced by shared Internet infrastructure that allows unrestricted two-way peer-to-peer communication. As another example, proprietary playback hardware is being replaced with general-purpose computers that allow use of software that enables media playback. However, the management of digital assets and access to digital assets such as content assets is often limited to the control of distribution systems that manage the commerce, usage rights, and control the playback infrastructure in a centralized fashion.

Managing rights and access to assets such as content assets is often complex and prone to workarounds. Current solutions lack sufficient means to assure any royalty payments for the use or access to the assets are made on a per use basis.

Improvements are needed.

### SUMMARY OF THE INVENTION

The present disclosure relates to Digital rights management (DRM) tools or technological protection measures (TPM), which may comprise a set of access control technologies for restricting the use of proprietary hardware and copyrighted works. DRM technologies try to control the use, modification, and distribution of copyrighted works (such as software and multimedia content), as well as systems within devices that enforce these policies. Systems and methods for decentralizing commerce and rights management for digital assets using a blockchain rights ledger in accordance with embodiments of the invention are disclosed.

Aspects of the disclosure relate to systems and methods for managing digital content by the content owner.

In an embodiment, A method for managing access control to a digital asset comprises receiving, via one or more nodes associated with a digital rights management system, an indication of a select non-fungible token (NFT) on a blockchain; receiving, via the one or more nodes, a digital asset; encrypting the digital asset to form an encrypted asset, wherein decryption of the encrypted asset is based on the select NFT; storing a credential indication that the select NFT is representative of an authentication credential for the encrypted asset; receiving, from a user device associated with a cryptographic wallet, a request to access the encrypted asset; causing a challenge request to be presented via the user device; receiving a signature to the challenge, wherein the signature is based on the cryptographic wallet; providing, based on validation that the cryptographic wallet owns the select NFT, a credential string to the user device; and allowing decryption and consumption of the encrypted asset based on a comparison of the credential indication and credential string meeting a matching threshold.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and the invention may admit to other equally effective embodiments.

FIG. 1 illustrates a content consumer electronic device.

FIG. 2 illustrates a content owner electronic device.

FIG. 3 illustrates an external service provider electronic device.

FIG. 4 illustrates an external storage provider electronic device.

FIG. 5 illustrates an exemplary signature request as part of a validation.

FIG. 6 illustrates a cryptographic challenge cryptographic wallet browser extension.

FIG. 7 illustrates content transmission.

FIG. 8 illustrates an example process in accordance with the present disclosure.

FIG. 9A illustrates an example process in accordance with the present disclosure.

FIG. 9B illustrates an example process in accordance with the present disclosure.

FIG. 9C illustrates an example process in accordance with the present disclosure.

Other features of the present embodiments will be apparent from the Detailed Description that follows.

### DETAILED DESCRIPTION

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention. Electrical, mechanical, logical, and structural changes may be made to the embodiments without departing from the spirit and scope of the present teachings. The following detailed description is therefore not to be taken in a limiting sense, and the scope of the present disclosure is defined by the appended claims and their equivalents.

### Term Definitions:

Non Fungible Token (NFT)—A unique serial number asset registered to a blockchain.

NFT ID—A unique serial number of an NFT smart contract (e.g. 0x:1 in ERC721 standard nomenclature). ERC 721=the standard for non-fungible tokens in Ethereum (ERC=Ethereum Request for Comments) which implements an API for tokens with smart contracts.

JSON—JavaScript Object Notation

JSON Web Token (JWT)—A browser cookie utilized to perform authentication functions.

Cookie—A piece of information stored in a user's browser cache for authentication.

Web Browser—A computing interface used to interact with the Internet.

Event Listener—A method of programmatically querying and updating a database based on new block information.

Source of truth—an element of data that is mastered in a single location to avoid the existence of different versions of the element in different locations.

Cryptographic wallet-Storage and retrieval software used to secure and transmit cryptocurrencies (e.g. Metamask, Niftywallet).

Security Node—A combination server and database architecture designed to facilitate NFT unlocked data streaming.

CDN: content delivery network.

The present disclosure relates to a blockchain-based distributed digital rights management platform that uses non-fungible tokens (NFTs) to gate access to streaming content. An NFT marketplace is powered by infrastructure that allows for quick deployment and integration. This solution set makes it easy for communities, businesses and creators to leverage their markets using non-fungible tokens. The platform may work as an end-to-end solution or incrementally through an application programming interface (API).

### Web Tokens and Validation

In accordance with the present disclosure, a web token (such as a cookie) or data string may be used to convey information from one electronic device to another electronic device. The data string may be or comprise a first party object such as a first party cookie. A JSON (JavaScript Object Notation) web token (JWT), for example, is one standard method or means of such a transfer of information, though other strings, web tokens, or browser cookies may be used.

As an illustrative example, a JWT comprises a header, a payload (also called the claims), and a crypto segment. The crypto segment may be a digital signature (asymmetric cryptography) or a message authentication code (symmetric cryptography). The crypto segment may comprise a hash of the header and a hash of the payload with a known hash function (e.g. SHA-256). The crypto segment may also comprise encryption using a secret key (for a symmetric cryptographic system) or a private key (for an asymmetric system).

When transmitted from one electronic device to another electronic device, the JWT has the benefit that the second electronic device can be reasonably certain that the token's information content (claims or payload) was not altered during transit and thus that it is receiving an unaltered header and payload from a known sender. When received by the second electronic device, the JWT is first verified by inspecting the crypto segment. Inspection of the crypto segment may comprise hashing the header and the payload and comparing the result to the crypto segment. An alternative (only applicable is the two senders have exchanged keys or at a minimum the public key) is to encrypt using the header and the payload using the known key and to compare with the crypto segment. The crypto segment is first decrypted using either the secret key (symmetric) or the public key (asymmetric) and then inspected to see whether it contains the hash of the header and the hash of the payload. If these match, then the token was not tampered during transit, and the originator is known to possess the ability to encrypt properly (using the same secret key or a private key which the public key may decrypt).

If a recipient does not immediately validate a web token upon receipt, then the recipient may be open to a security breach exploiting this lack. An alternative type of initial validation takes the form of either a challenge-response. For instance, a sender may send an encrypted large integer to a recipient. The correct answer to this challenge, may be that the recipient replies by increasing the integer by one, encrypting the result and sending the encrypted result back to the sender. The sender may decrypt and check that the recipient gave the correct response. This correct challenge and response will inform the original sender that the recipient has the proper key for encrypting and decrypting and knows the answer to the challenge. As noted above, other alternative authentication mechanisms such as challenge-response may be used instead of inspecting the hash of the payload, as is known to those of skill in the art of cryptography.

As an illustrative example, the body of the JWT may be injected with a custom nonce (string) that must match the corresponding hash in the secure key storage vault. If they match the content streams, if not the data will not load.

Another exemplary method of verification may comprise the consumer signing the challenge when responding. The digital signature may comprise an encrypted hash of the message to verify that the security node can decrypt the message and also that the message was not altered after it was generated and sent by the consumer. For such verification to occur, the consumer must already be a registered user with the security node, so that both the consumer and the user either know the correct key for encrypting and decrypting messages, or that the consumer and the user are familiar with each other's public keys in a public/private key (asymmetric) encryption system.

As an example, a message authentication code (MAC) may be used as a digital signature, but distinct from a signature. MAC is used with a secret key (symmetric), but a digital signature (in the cryptographic sense) is used with a public/private key set (asymmetric). Using this method demonstrates that someone in possession of the secret key (or the public key) signed the payload.

### A Process Flow

As an illustrative example, a user (e.g., creator) selects/creates a non-fungible token on a blockchain to act as an authentication credential. A database such as a database associated with the DRM service (e.g., RAIR node database) receives information indicative of instructions to use selected NFT as the required credential to unlock.

A user uploads data to a node associated with the DRM/playback service (e.g., the RAIR node). This process uploads the file, encrypts the file to only be unlocked by the correct NFT access credential. Then deletes the unencrypted file from the system.

A user wishes to stream encrypted data. They first sign into the system with a cryptographic wallet. This generates a challenge request which they must confirm with their cryptographic wallet by signing the challenge.

If the cryptographic challenge is successfully solved by signing with the cryptographic wallet that the end user owns the correct NFT, access is granted and the encrypted stream's bandwidth is unlocked to stream packets of information.

This may be accomplished by injecting a custom message into the body of a string such as a cookie (e.g., JSON web token (JWT)) cached into a user's web browser. Upon user request, the DRM service (e.g., RAIR node) checks if the cryptographic payload in the body of the JWT matches the entry in the private RAIR node database (secret sharing scheme).

If the JWT matches the database entry then the challenge is solved and the stream plays. JWTs can be configured to expire at any interval desired by the Creator. When expired, a new JWT must be generated and cached into the user's browser to unlock streaming capabilities.

When any event related to the NFT ID is triggered on the blockchain an event is captured by an event listener. The internal database is then updated to reflect the change for system performance. A failover to look directly on the blockchain is performed if no database result is found.

An owner or rights holder of digital content may provide such digital content to others for a fee, or other considerations, as desired. These other considerations may comprise, for instance, including a royalty paid to the content's initial creator or to co-owners of the content or to a partial co-creator. To enable such transactions to occur without making the digital content available to all for no compensation, the owner may encrypt the digital content before storing it. The owner may, optionally, also fragment or segment the digital content prior to encrypting the content, to make the content easier to transmit over a transmission channel, for instance. The owner may also wish to confirm that payment was received prior to permitting a potential consumer to access the content by sharing a key for decryption of the digital content. In the case of symmetric cryptographic systems, the content owner may encrypt the digital content using a secret key, and then store the secret key in a vault, perhaps run by a trusted third party. In the case of asymmetric cryptographic systems, the content owner may encrypt the digital content using a public key, and then store the corresponding private key. Such storage may be in a vault, for example, operated by a trusted third party. The vault may store the key, and will only provide the key to an interlocutor who has been authenticated by the owner.

The trusted third party or the service provider may also be obligated to meet regulatory requirements, such as know your customer and anti-money laundering provisions for financial services, which may require greater information sharing between a service provider and a customer or content owner. In addition, a content owner must accept liability for all content uploaded to a secure node.

A non-fungible token (NFT or an NFT) on a blockchain. Various platforms may be used. The NFT may comprise details about the content, metadata about the content such as the creator(s), the location of the creation, when the content was created, how the content was created, why the content was created, and/or a unique identifier of the content. A user may purchase the NFT using any exchange or platform that enables such transfer and recordation on a blockchain. Once the NFT is purchased, a wallet used to purchase the NFT is addressed in the transaction and may be validated to provide the transaction has occurred.

The payload of the JWT may have the location of the NFT on the blockchain, which the consumer's electronic device may access. The NFT may contain a unique identifier associated with the session and with the content being requested. The consumer's electronic device may then send a message to the vault containing the key for decrypting the digital content. The vault may authenticate that the request is legitimate by confirming that the unique identifier in the NFT corresponds with that particular cryptographic key. One method of such authentication may be by verifying with the cryptocurrency hash that the transaction between the two parties (the owner and the consumer) has occurred. Once the vault has authenticated the transaction, it will release the cryptographic key to the consumer's electronic device. With the cryptographic key, the consumer's electronic device may decrypt the encrypted digital content. The consumer's electronic device may also require certain permissions from the web token for the content to play in the web browser. For instance, the limitations or permissions may comprise consuming the content a limited number of times, or bound the time when the content may be consumed. These limitations may take the form of a smart contract. For instance, if a user is given the contracts: 0xABCEthereumcontract/0 . . . 0xABCEthereumcontract/100, where the last number ranges from 0 to 100, then they may be permitted to view a video (e.g. specialvideol.mp4). If the last number is 101, then the video will not stream.

In an example, payment may occur using an Ethereum wallet and a smart contract may include the EIP-2981 royalty standard. The wallet ledgers the transfer of cryptocurrency in near real time. Once the transfer has occurred both parties can confirm that the exchange has taken place. When the content owner wishes to enable the consumption of the digital content by the consumer, the owner may validate the consumer using a nonce string as part of the web token's payload. Using a nonce string for verification may help ensure that there are no bugs in the transfer process, particularly between APIs or RPC bridges between networks. In an example, when the owner's device issues the web token, it may also notify a trusted third party (e.g. a vault) in which a cryptographic key may be stored and also notify the vault of the unique identifier associated with the content so that the vault may release the appropriate key onto the correct consumer (or the consumer's device). In an example of an alternative authentication protocol, the consumer may request a nonce protocol for authentication rather than use the standard JWT authentication step (comparison of the crypto segment with the hash of the header and the hash of the payload).

The decryption key for the digital content may be held in a vault, or in another secured location. For example, any private database that can securely store secrets may also be used. For insurance and contractual guarantee reasons, the private database in practice must be a managed service where these other requirements may be met.

The content owner may choose to have this entire process maintained by a third party, such as by a company which manages the process. Such a trusted third party may have its own nodes for uploading digital content as well as its own methods for fragmentation of the content and encryption of the content. In an example, each instance of the downloadable content may have an associated NFT, unique to that content and to that consumer's request for the content. Multiple consumers may agree on the instance for a transaction or agree to multiple versions, but the files themselves exist only as a unique instance, once compiled and the relevant NFT has been created.

### Notes on Operation

When the content consumer wishes to consume the digital content, the consumer must use a web browser to gain access, as noted above. The web token may also be utilized to set permissions which limit the use of the digital content. Also, a custom message may be injected into the payload of the JWT to unlock the required bandwidth when the web token is cached into a user's web browser.

Yet another method of authentication or verification may comprise an event listener, which records and stores changes in the blockchain. When any event related to the NFT ID is triggered on the blockchain, that event is captured by an event listener, which stores this event in, for instance, a database. This database may be accessed by the vault, as another method for verifying that the vault should release to the consumer the cryptographic key associated with the content. Such a database may also be updated to reflect the change for system performance. The vault may also switch to look directly at the blockchain, if the database fails and is switched over as a backup.

### Example(s)

As an example, suppose a digital content consumer wishes to watch a video. The video is owned by a content owner, who wishes to be paid for use of their content or to limit the use of the video. The consumer sends a request to see the digital content. The request may take the form of a web token, cryptographic cookie, or the like. The web token may further comprise a reference to a cryptocurrency wallet, such as the consumer's wallet. Some exemplary cryptocurrency wallets include Metamask or Niftywallet. Other options comprise using other forms of electronic payment, such as credit cards, debit cards, cash transfer methods, wire payments, or electronic currencies and their equivalents. The owner's device (or the security node, depending on the service agreement with the content owner) receives the consumer's JWT and validates it by, for example, one of the methods listed above so that the content owner is sure that the JWT originated from the content consumer/user. This validation of the web token should occur prior to allowing API calls to avoid malicious actions. Once validation is completed, the content owner can receive payment by, for instance, ledgering the electronic currency from the consumer's wallet to the owner's wallet. For instance, if the cryptocurrency accounts are on Ethereum, then the appropriate amount of ether must be transferred.

The payload of the JWT may include a hash of the consumer's cryptocurrency wallet (e.g. the Ethereum wallet public key) for validation purposes to prove that the consumer (or the sender) is the rightful owner of that cryptowallet.

The content owner's device may then send a web token to the content consumer's device with information about the location of the NFT for gaining access to the key to decrypt the content. In addition, the JWT may have other limitations on the consumption of the digital content, such as limiting the number of times it may be consumed, or when it may be consumed. These other limitations may be enacted by the incorporation of these statements when the web token is cached into the consumer's web browser.

The use of JWTs enables proof of provenance of the digital content and may also comprise options for hybrid custody of the digital content. The JWT may also comprise royalties, customizable by, for example, various market conditions or other factors. The JWT enables the content owners or creators may be allowed to mint, distribute, and control access to their content, regardless of where it is located physically.

One or more authenticated session may use a unique JWT/secret storage vault connection. Tokens can be set to expire at any interval in time (e.g. after 10 seconds, 10 minutes, 10 years, etc.). Once the session is authenticated the consumer can stream as many times as they want until the session expires.

Content assets or segments of the assets may be transmitted as an encrypted stream (e.g. using the http live stream (HLS) standard or other platform streaming protocol) . . . . In an example, encryption may occur by using the AES-128 standard to optimize, for instance, performance. Since asymmetric encryption schemes generally require more computing resources and so may delay the watching of a streamed video while the computer decrypts the incoming data stream, symmetric schemes may be preferred for performance reasons. Other encryption schemes (e.g. asymmetric) can be swapped in if the security needs of the users are more important than the performance requirements.

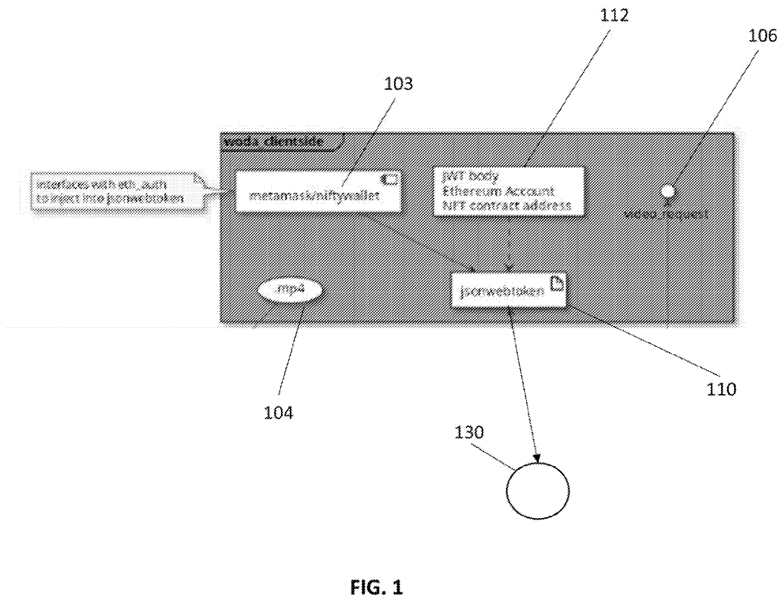

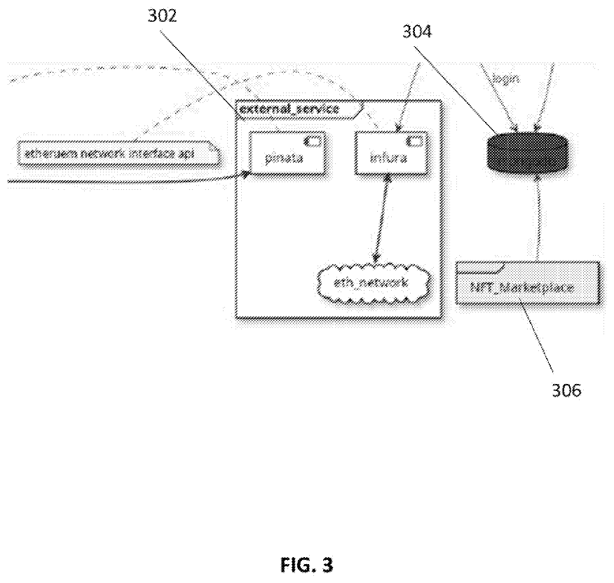

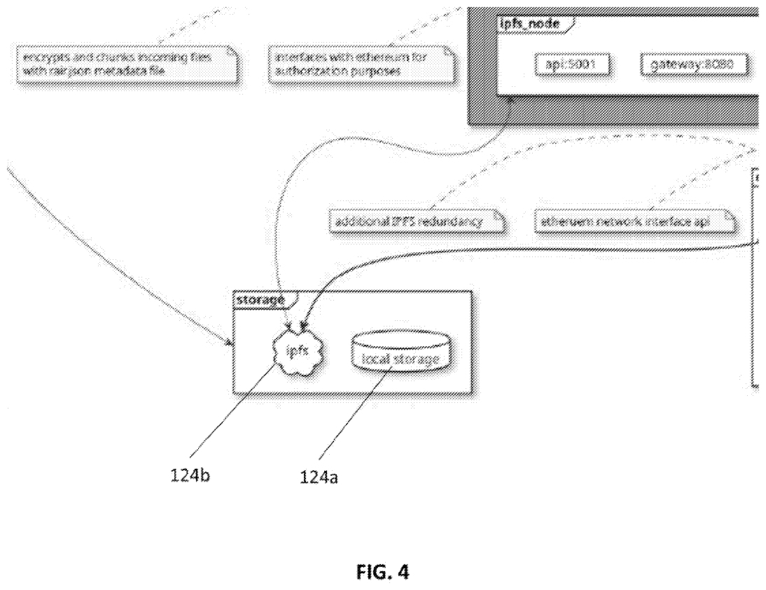

FIGS. 1-9C illustrate some aspects of the present disclosure. A content owner or rights holder may have access to a cryptocurrency wallet 102 (“owner's wallet”) and a content consumer may have access to a cryptocurrency wallet 103 (“consumer's wallet”). A user may desire to make digital content 104 available for consumption (e.g., playback) to those that have authenticated access. In accordance with the present disclosure, such authenticated access may be validated using NFTs as an indicator of the right to access this digital content 104. By way of example, the content owner (or other user having permissions) may select an NFT 118 to be associated with unlocking the rights to the underlying digital content 104. Such a selection may comprise providing an indication (NFT contract address) to the DRM service (e.g., RAIR node) of the NFT 118. In this way, the NFT 118 may be identified as the unlocking credential.

A user such as the content owner may upload digital content 104 to a node (e.g., RAIR node) for storage. As an example, the content 104 may be or comprise a data file (e.g., mp4) that may represent at least a portion of a digital asset. The digital content 104 may be encrypted into a new file/format (e.g., video stream). The unencrypted content 104 may be deleted. The encryption of the digital content 104 is configured to be decrypted based on proof of ownership of the identified NFT 118. For example, a key for decryption may be selectively provided to those that can prove ownership of the NFT 118.

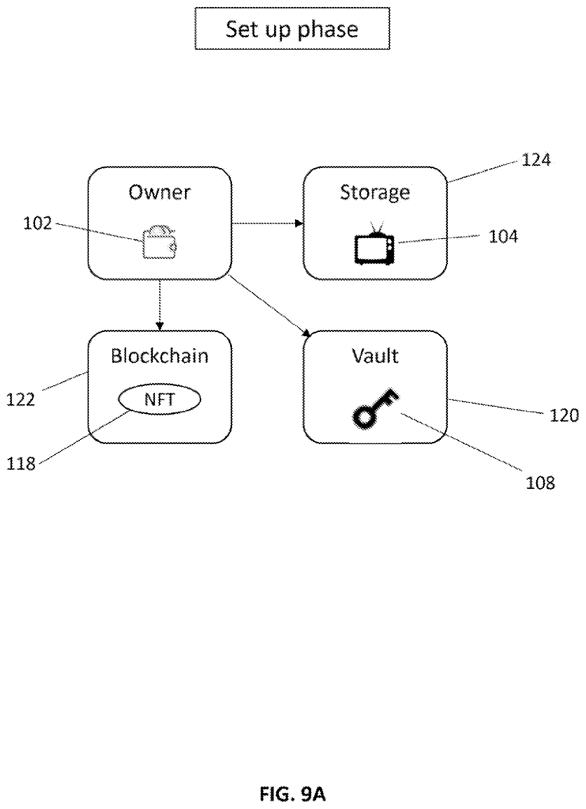

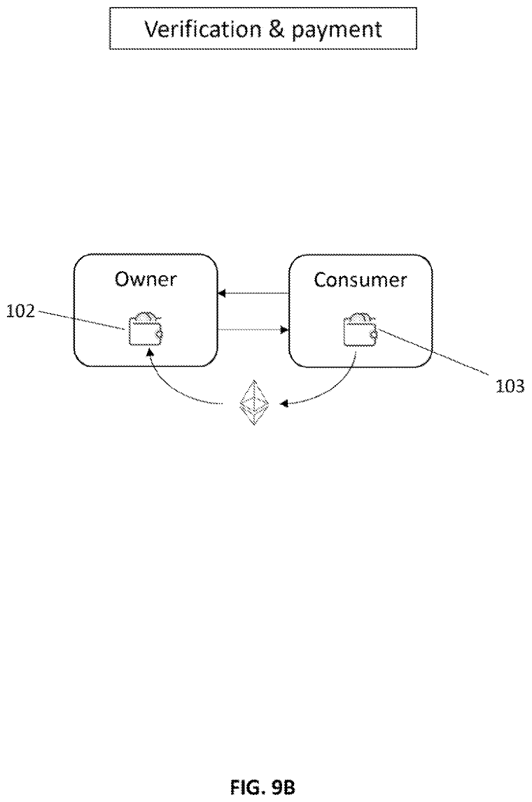

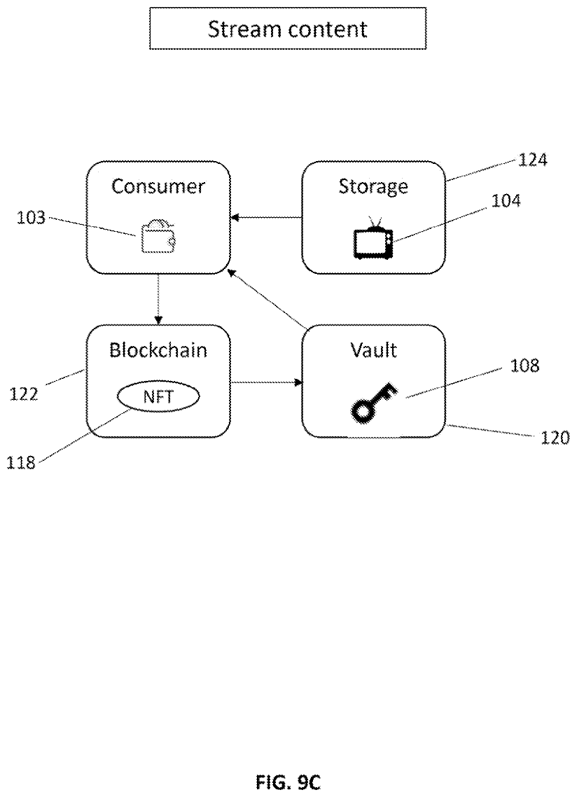

As more clearly sown in FIG. 9A, the content owner establishes a digital wallet 102 for receiving payments for the digital content 104. The digital content 104, is located in some storage 124. The storage 124 may be local or remote and may be under direct control of the owner or managed by others. The digital content 104 is stored in storage 124, but only in encrypted form (e.g., encrypted based on the NFT 118 as the unlocking credential). The digital content 104 may also be fragmented prior to storage to aid in preventing unauthorized users and also to aid in transmission of the digital content 104. The content owner may also store a cryptographic key 108 for decrypting the digital content 104 in a vault 120. This key 108 may be a secret key of a symmetric cryptographic system or it may be the public key 108a or the private key 108b of an asymmetric cryptographic system. An example of a symmetric system is AES-128. An example of an asymmetric system is the RSA encryption algorithm. When referring to simply a cryptographic key 108 or a key 108, no distinction needs to be made which type of system is being used. In addition, to storing the key 108 in the vault 120, the owner also record a transaction relating to the NFT 118 on a blockchain 122. The NFT 118 may comprise information related to the digital content including a unique identifier, which will correspond to the key 108 for that content stored in the vault 120.

An end user/consumer may would like to consume the digital content 104 (e.g. music or an audiobook to listen to or a video they wish to view). In order to gain access to the encrypted digital content 104, the consumer must first prove that they own the NFT 118 that has been identified as the unlocking credential. As an example, the consumer may first engage in a transaction between wallets 102/103 to record an ownership of the NFT 118 associated with the consumer's wallet 103. This may be accepted peer-to-peer or via a service platform. Various means for acquiring the NFT 118 may be used.

An end user/consumer may would like to consume the digital content 104 (e.g. music or an audiobook to listen to or a video they wish to view). In order to gain access to the encrypted digital content 104, the consumer must first prove that they own the NFT 118 that has been identified as the unlocking credential. As an example, the consumer may first engage in a transaction between wallets 102/103 to record an ownership of the NFT 118 associated with the consumer's wallet 103. This may be accepted peer-to-peer or via a service platform. Various means for acquiring the NFT 118 may be used.

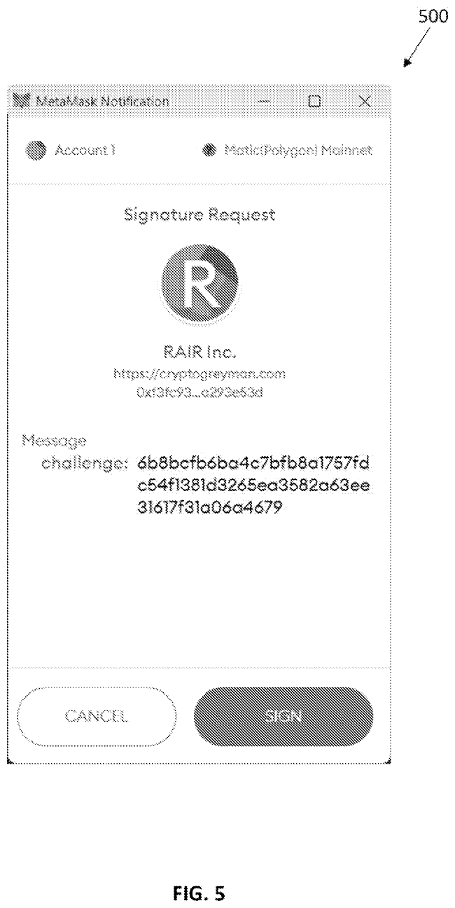

As more clearly shown in FIG. 9C, when the consumer wishes to stream the encrypted digital content 104, the consumer signs into the DRM system/playback system with a cryptographic wallet (e.g., consumer wallet 103). The sign-in generates a challenge request (see FIG. 5), which must be confirmed with their cryptographic wallet by signing the challenge. By signing the challenge, the DRM service may confirm that the wallet used to sign the challenge is the recorded owner of the NFT 118. Once the ownership of the NFT 118 is validated on the blockchain, a string (web token, JWT 110) may be inserted into the web browser of the consumer that indicates to the DRM service (RAIR node) that the consumer owns the NFT 118. As an illustrative example, this may be accomplished by injecting a custom message into the body of a JSON web token (JWT) cached into a user's web browser. Upon user request, the DRM service (e.g., RAIR node) checks if the cryptographic payload in the body of the JWT matches the indication of the unlocking credential (e.g., entry in the private RAIR node database (secret sharing scheme)).

If the cryptographic challenge is successfully solved by signing with the cryptographic wallet that also demonstrates that the consumer owns the correct NFT 118, access is granted and the encrypted stream's bandwidth is unlocked to stream packets of information from the encrypted digital content 104. As an example, decryption key may be provided to the consumer to unlock the encrypted digital content 104 after the NFT ownership has been validated using the information in the injected string (JWT). As an example, if this verification succeeds, then the vault 120 holding the key may send to the consumer the key 108. The consumer then can stream the digital content 104 from the storage 124, and decrypt it locally. The ability of the consumer to stream the digital content 104 may be further limited by other information from the web token 110, such as time-delimited, or number of times it can be consumed before the web token 110 expires.

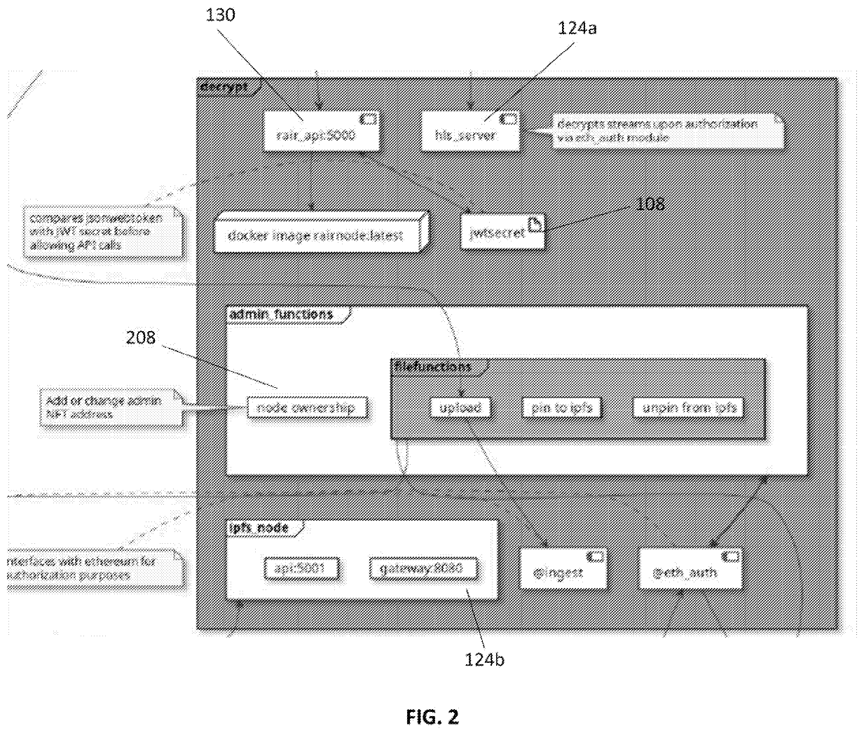

FIG. 2 illustrates administration functions such a keeping track of NFTs 118, fragmenting and storing the content 104 in local storage 124a or in remote storage 124b. Other services 302 (e.g. Piñata or Infura) may be employed to help host the files on remote storage 124b such as, for example on IPFS. In addition, other databases 304 (e.g. MongoDB) may also be involved, as well as the existence of an NFT Marketplace 306.

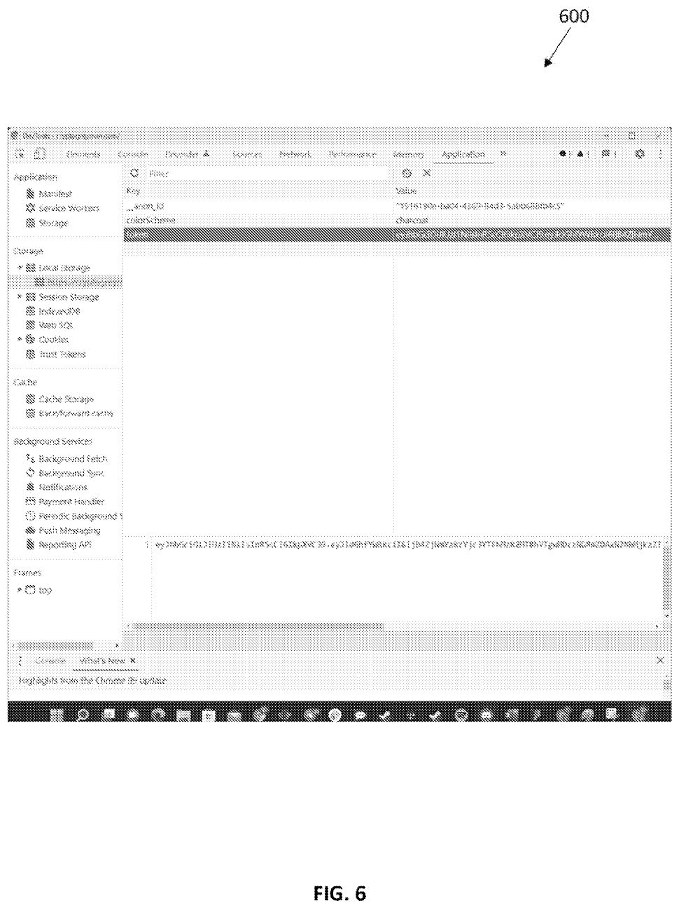

FIG. 5 illustrates a signature request with a challenge. In this example, the user is being requested to sign in to a Metamask cryptographic wallet browser extension. The challenge is encrypted so that only a counterparty with the appropriate key can decrypt the challenge and answer correctly. FIG. 6 illustrates a token (a JWT) in a browser (Google Chrome, in this example) in local storage.

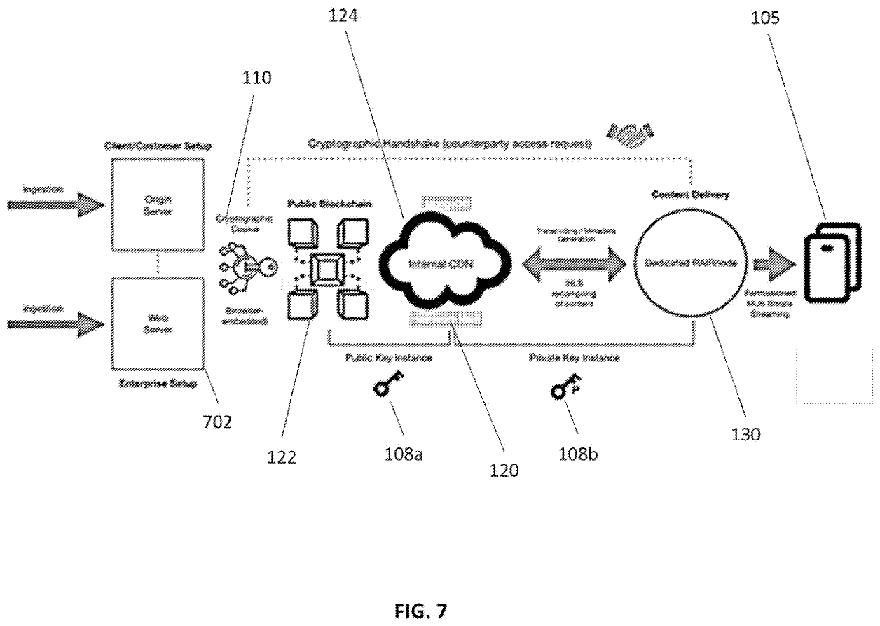

FIG. 7 illustrates the content transmission. First consumer and originator perform set up of their respective wallets and accounts. The content owner may set up the service on a web server 702. The owner has encrypted a file using a public key 108a and stored the file(s) on remote storage 124 (Internal CDN in the example shown in FIG. 7). In addition, the private key 108b is stored in the vault 120 (Hashicorp Vault, in this example) and is associated with a unique identifier of the digital content 104. An NFT 118 with this unique identifier is stored on the blockchain 122. The customer indicates their wish to stream content. After authentication and transfer of payment, the vault 120 releases the private key 108b to the consumer's device. In addition, the other limitations on the consumption of the digital content 104 come in to play as the content 104 is streamed to the consumer's device 105. The content 104 is delivered to the device 105, but the limitations on use still apply and may be managed by a security node 130.

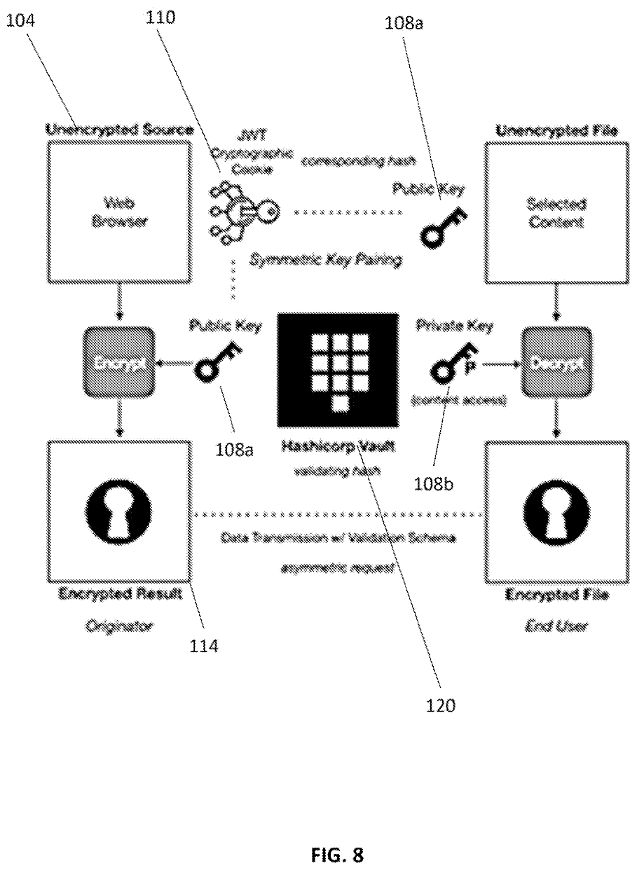

FIG. 8 illustrates some example validation steps. The digital content 104 may be encrypted using a public key 108a, and stored as encrypted digital content 114. The private key 108b may be stored in a vault 120 (the Hashicorp Vault in this example). In an alternative example, the secret key 108a may be stored in the vault 120. When the consumer requests the digital content 104, the initial process of validation/authentication and payment occurs. Once the consumer has received the NFT 118, the consumer may then request the key 108 (either the private key 108b, or the secret key 108a which was used to encrypt the digital content 104) from the vault 120. After the vault 120 has validated that the request is legitimate, the vault 120 may send the key 108 to the consumer's device 105 so that the consumer's device 105 may decrypt the encrypted digital content 114 to consume the digital content 104 on the consumer's own device 105.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s).

In some alternative implementations, the functions noted in the blocks may occur out of the order noted in the Figures. For example, two blocks shown in succession may, in fact, be executed substantially concurrently, or in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or that carry out combinations of special purpose hardware and computer instructions. Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

From the above description, it can be seen that the present invention provides a system, computer program product, and method for the efficient execution of the described techniques. References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of 35 U.S.C. section 112, sixth paragraph, unless the element is expressly recited using the phrase “means for” or “step for.”

While the foregoing written description of the invention enables one of ordinary skill to make and use what is considered presently to be the best mode thereof, those of ordinary skill will understand and appreciate the existence of alternatives, adaptations, variations, combinations, and equivalents of the specific embodiment, method, and examples herein. Those skilled in the art will appreciate that the within disclosures are exemplary only and that various modifications may be made within the scope of the present invention. In addition, while a particular feature of the teachings may have been disclosed with respect to only one of several implementations, such feature may be combined with one or more other features of the other implementations as may be desired and advantageous for any given or particular function. Furthermore, to the extent that the terms “including”, “includes”, “having”, “has”, “with”, or variants thereof are used in either the detailed description and the claims, such terms are intended to be inclusive in a manner similar to the term “comprising.”

Other embodiments of the teachings will be apparent to those skilled in the art from consideration of the specification and practice of the teachings disclosed herein. The invention should therefore not be limited by the described embodiment, method, and examples, but by all embodiments and methods within the scope and spirit of the invention. Accordingly, the present invention is not limited to the specific embodiments as illustrated herein, but is only limited by the following claims.

The invention claimed is:

1.-7. (canceled)

8. A method for managing access control to a digital asset, the method comprising:
receiving an indication that a non-fungible token (NFT) on a blockchain is selected to act as an authentication credential;
receiving, via a centralized node, user data;
causing, using the user data, the generation of encrypted user data, wherein the encrypted user data is only unlocked using an NFT access credential associated with the NFT;
causing removal or deletion of the unencrypted user data from the centralized node;
receiving, via the centralized node and from a user device, an access request for the encrypted user data, wherein the access request is associated with a cryptographic wallet,
causing a challenge request to be presented via the user device;
receiving a signature to the challenge, wherein the signature is generated using the cryptographic wallet;
providing, based on validation that the cryptographic wallet owns the NFT, a credential string to the user device; and
allowing decryption and consumption of the encrypted user data based on a comparison of the NFT access credential and the credential string meeting a matching threshold.

9. The method of claim 8, wherein the user device comprises a web browser and the credential string is stored as a token on the web browser.

10. The method of claim 8, wherein the credential string comprises a first party object.

11. The method of claim 8, wherein the credential string comprises a first party cookie.

12. The method of claim 8, wherein the user device comprises a web browser and wherein causing a challenge request to be presented via the user device is implemented via a browser extension.

13. The method of claim 8, wherein the user device comprises a web browser and wherein receiving a signature to the challenge is implemented via a browser extension.

14. The method of claim 8, wherein the user device comprises a web browser and wherein providing, based on validation that the cryptographic wallet owns the NFT, a credential string to the user device is implemented via a browser extension.

15. A method for managing access control to a digital asset, the method comprising:
receiving, via a node associated with a digital rights management system, an indication of a select non-fungible token (NFT) on a blockchain;
receiving, via the node, a digital asset;
encrypting the digital asset to form an encrypted asset, wherein decryption of the encrypted asset is based on the select NFT;
storing a credential indication that the select NFT is representative of an authentication credential for the encrypted asset;
receiving, from a user device associated with a cryptographic wallet, a request to access the encrypted asset;
causing a challenge request to be presented via the user device;
receiving a signature to the challenge, wherein the signature is based on the cryptographic wallet;
providing, based on validation that the cryptographic wallet owns the select NFT, a credential string to the user device; and
allowing decryption and consumption of the encrypted asset based on a comparison of the credential indication and credential string meeting a matching threshold.

16. The method of claim 15, wherein the user device comprises a web browser and the credential string is stored as a token on the web browser.

17. The method of claim 15, wherein the credential string comprises a first party object.

18. The method of claim 15, wherein the credential string comprises a first party cookie.

19. The method of claim 15, wherein the user device comprises a web browser and wherein causing a challenge request to be presented via the user device is implemented via a browser extension.

20. The method of claim 15, wherein the user device comprises a web browser and wherein receiving a signature to the challenge is implemented via a browser extension.

21. The method of claim 15, wherein the user device comprises a web browser and wherein providing, based on validation that the cryptographic wallet owns the NFT, a credential string to the user device is implemented via a browser extension.

22. A method for managing access control to a digital asset, the method comprising:
receiving, via a node associated with a digital rights management system, an indication of a select encrypted asset that is encrypted based on a select non-fungible token (NFT) on a blockchain;
receiving, from a user device associated with a cryptographic wallet, a request to access the encrypted asset;
causing a challenge request to be presented via the user device;
receiving a signature to the challenge, wherein the signature is based on the cryptographic wallet;
validating, based on the signature, that a user owns a select non-fungible token; and
allowing decryption and consumption of the encrypted digital asset based on the validating that a user owns a select non-fungible token.

23. The method of claim 22, wherein the user device comprises a web browser and the credential string is stored as a token on the web browser.

24. The method of claim 22, wherein the credential string comprises a first party cookie.

25. The method of claim 22, wherein the user device comprises a web browser and wherein causing a challenge request to be presented via the user device is implemented via a browser extension.

26. The method of claim 22, wherein the user device comprises a web browser and wherein receiving a signature to the challenge is implemented via a browser extension.
